(19) United States
(12) Patent Application Publication
(10) Pub. No.: US 2019/0237905 A1
(43) Pub. Date: Aug. 1, 2019

(54) Panels with Mirrored Connectivity

(71) Applicant: David Lynn, Welcome, NC (US)

(72) Inventor: David Lynn, Welcome, NC (US)

(21) Appl. No.: 15/882,634

(22) Filed: Jan. 29, 2018

(51) Int. Cl. H01R 13/642; H01R 12/70; H01R 43/20

(52) U.S. Cl. CPC H01R 13/642; H01R 43/205; H01R 12/7088; H01R 12/7005

(57) ABSTRACT

Panels that electrically connect with one or more adjacent structures. The panels include a body with outer sides. Electrical connectors are positioned along each at least two of the outer sides to electrically connect the panel to one or more adjacent structures. Two or more of the sides are divided about a mirror line into two different sections. The electrical connectors positioned along each of the sections are arranged in a mirror image about the mirror line. The mirror image positioning of the electrical connectors along two or more of the sides provides for the panel to be electrically connected to the one or more adjacent structures when the panel is in different orientations.

### BACKGROUND

The present application is directed to panels and, more particularly, to panels equipped with connectors to electrically couple with one or more adjacent structures.

Panels with electrical connectivity can be used in a wide variety of contexts. Panels include but are not limited to solar panels, wall panels, glass panels (e.g., windows, doors), ceiling panels, and internal building panels constructed from a variety of materials such as sheetrock, plywood, and fiberglass. The panels can include electrical connectors along an outer side to electrically connect with other structures, such as other panels or support members.

The electrical connectors along the outer side require that the panels be oriented in a specific orientation to electrically connect to the other structures. By way of example, if the panel includes electrical connectors along a single side, that side must be oriented towards the structure to which the panel is to be electrically connected. The panel cannot be oriented with that side facing away from the structure as this would prevent the electrical connection.

Panels with limited electrical connectors can be more difficult to use. These types of panels have more limited applicability as they should be attached in a particular orientation. Further, these panels can be more difficult to install and/or more likely to be installed incorrectly. A worker that is installing the panel is required to properly orient the panel. If the worker is not paying attention, the panel will be installed without electrical connectivity.

### SUMMARY

The present application is directed to panels that include at least two sides with mirrored arrangements of electrical connectors.

One aspect is directed to a panel that includes a body with a top surface, an opposing bottom surface, and outer sides that extend between the top and bottom surfaces. A mirrored arrangement of electrical connectors is positioned on at least two of the outer sides. Each of the outer sides includes a mirror line positioned at a center of the outer side, a first arrangement of the electrical connectors on a first side of the mirror line, and a second arrangement of the electrical connectors on an opposing second side of the mirror line. Each of the first and second arrangements includes a common number, electrical attribute, and spacing of the electrical connectors.

In another aspect, each of the first and second arrangements of the electrical connectors include at least one ground connector, at least one positive electrical connector, and at least one negative electrical connector.

In another aspect, each of the first and second arrangements of the electrical connectors share a single connector that is positioned on the mirror line.

In another aspect, the mirrored arrangement of electrical connectors is positioned on each of the outer sides of the body.

In another aspect, the mirror lines of two of the outer sides of the body are co-linear.

In another aspect, the mirrored arrangement of a first one of the outer sides is different than the mirror arrangement of a second one of the outer sides.

In another aspect, each of the electrical connectors includes an arm attached to the body and an electrical contact.

In another aspect, each of the electrical connectors is electrically connected to an electrical bus that is attached to the body.

Another aspect is directed to a panel that includes a body with a top surface, an opposing bottom surface, a first outer side, and a second outer side. A mirrored arrangement of electrical connectors is positioned on each of the first and second outer sides. Each of the mirrored arrangements includes: a mirror line; a first pair of connectors with first and second connectors that each have a first electrical attribute and with the first connector positioned a first distance away from the mirror line on a first side of the mirror line and the second connector positioned the first distance away from the mirror line on a second side of the mirror line; a second pair of connectors with third and fourth connectors that each have a different second electrical attribute with the third connector spaced away from the first connector and positioned a second distance away from the mirror line on the first side of the mirror line and the fourth connector spaced away from the second connector and positioned the second distance away from the mirror line on the second side of the mirror line.

In another aspect, each mirrored arrangement includes a fifth connector with a third electrical attribute and with the fifth connector positioned at the mirror line.

In another aspect, the fifth connector is a ground connector.

In another aspect, the panel also includes a third pair of connectors with fifth and sixth connectors. The fifth connector is spaced away from the first and third connectors and positioned a third distance away from the mirror line on the first side of the mirror line and the sixth connector is spaced away from the second and fourth connectors and positioned the third distance away from the mirror line on the second side of the mirror line.

In another aspect, one of the first and second pairs of electrical connectors has a negative polarity and the other of the first and second pairs of electrical connectors has a positive polarity.

In another aspect, each of the electrical connectors includes an arm attached to the body and an electrical contact that is exposed on the arm.

In another aspect, each of the mirrored arrangements includes at least one ground connector, at least one positive electrical connector, and at least one negative electrical connector.

In another aspect, the panel also includes an electrical bus connected to the body and being electrically connected to each of the electrical connectors.

In another aspect, the mirror lines of the first and second outer sides of the body are co-linear.

In another aspect, the first and second outer sides include no additional electrical connectors.

Another aspect is directed to a method of electrically connecting a panel to an adjacent structure. The method includes positioning a first side of the panel towards the structure. The method includes aligning a first set of electrical connectors on the first side of the panel with corresponding electrical connectors on the structure with the first set of electrical connectors aligned along first and second sections positioned on opposing sides of a mirror line and having identical spacing and type of connectors. The method includes positioning a second set of electrical connectors on a second side of the panel away from the structure with the second set of electrical connectors having the identical spacing and type of connectors as the first set of electrical connectors. The method includes electrically connecting the first set of electrical connectors with the corresponding electrical connectors on the structure and positioning the second set of electrical connectors away from the structure.

In another aspect, the method also includes: disconnecting the first set of electrical connectors from the corresponding electrical connectors on the structure; positioning the second side of the panel towards the structure; and electrically connecting the second set of electrical connectors with the corresponding electrical connectors on the structure and positioning the first set of electrical connectors away from the structure.

The various aspects of the various embodiments may be used alone or in any combination, as is desired.

### BRIEF DESCRIPTION OF THE DRAWINGS

FIG. 1 is a schematic plan view of a panel with sides having connectors with a mirrored arrangement.

FIG. 2 is a schematic plan view of a panel with sides having connectors with a mirrored arrangement.

FIG. 3 is a schematic plan view of a panel with sides having connectors with a mirrored arrangement.

FIG. 4 is a schematic plan view of a panel with sides having connectors with a mirrored arrangement.

FIG. 5 is a schematic plan view of a panel with sides having connectors with a mirrored arrangement.

FIG. 6 is a side schematic view of a panel body with electrical connectors.

FIG. 7 is a schematic plan view of a panel with sides having connectors with a mirrored arrangement.

FIG. 8 is a perspective view of a panel array.

FIG. 9 is a schematic section view of a panel connected to support members.

FIG. 10 is a schematic section view of a panel connected to a support member.

FIG. 11 is a schematic plan view of a panel.

FIG. 12 is a perspective view of an array that includes multiple panels connected to a frame.

FIG. 13 is a schematic side view of one side of a panel connected to support members.

FIG. 14 is a schematic side view of one side of a panel connected to a support member.

FIG. 15 is a schematic plan view of a panel with sides having connectors with mirrored arrangements.

### DETAILED DESCRIPTION

The present application is directed to panels configured to electrically connect with one or more adjacent structures. The panels include a body with outer sides. Electrical connectors are positioned along at least first and second sides. Each of these sides is divided about a mirror line into two different sections. The electrical connectors positioned along each of the sections are positioned in a mirrored arrangement. The mirror arrangement provides for the panel to be electrically connected to the adjacent structures when the panel is in different orientations.

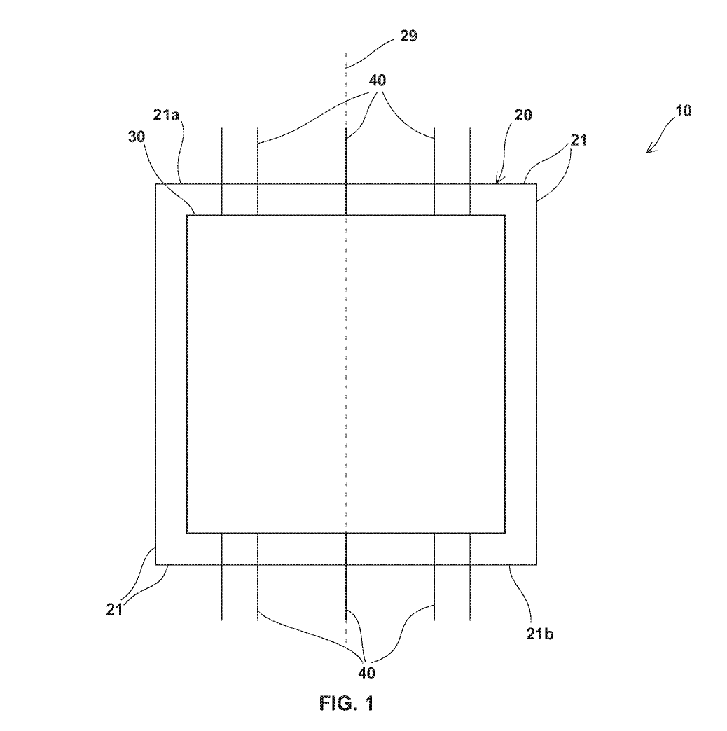

FIG. 1 schematically illustrates a panel 10 that includes a panel body 20. The panel body 20 is shaped with a number of outer sides 21. An electrical bus 30 is positioned along the panel body 20. Electrical connectors 40 are electrically connected to the bus 30 and are positioned along at least two of the outer sides 21a, 21b. The electrical connectors 40 along these sides 21a, 21b are arranged in a mirrored arrangement laterally outward from a mirror line 29. This provides for the two sides 21a, 21b to each be connectable to an adjacent structure.

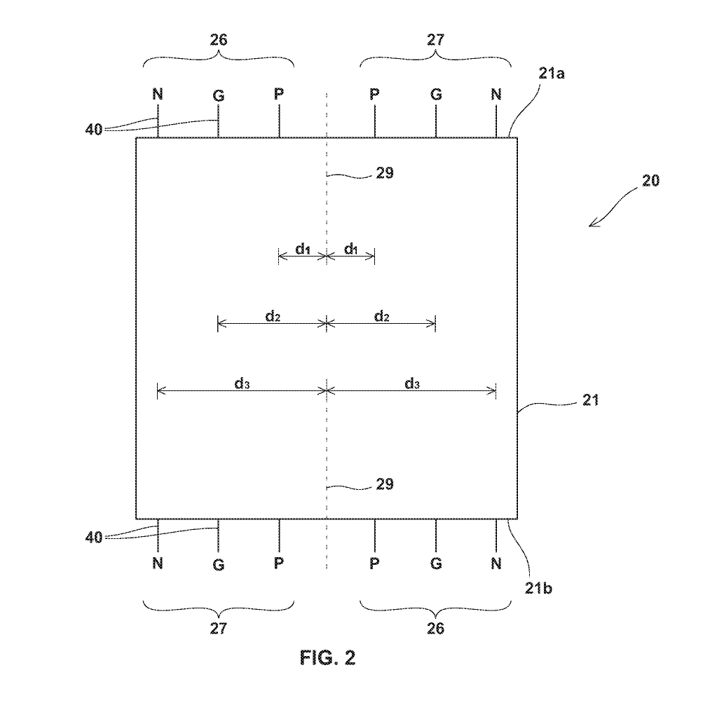

A mirrored arrangement of electrical connectors 40 along two or more of the outer sides 21 of the panel body 20 is illustrated in FIG. 2. This panel body 20 includes electrical connectors 40 positioned along sides 21a, 21b. The electrical connectors 40 can include one or more different electrical attributes such as but not limited to polarity, AC or DC connections, and phase. FIG. 2 includes an electrical attribute being polarity, with different connectors 40 being positive P, negative N, and ground G. The order of the polarity of the connectors 40 can vary. FIG. 2 include positive P connectors 40 closest to the mirror lines 29, followed by ground G connectors 40, and negative N connectors 40. Other configurations can include the connectors 40 arranged in a different order of polarity.

Mirror lines 29 divide each of the sides 21a, 21b into first and second sections 26, 27. The electrical connectors 40 are arranged in a common, mirrored arrangement about the lines 29 on each of the two sides 21a, 21b. As illustrated in FIG. 2, the mirrored arrangement includes that each side includes a pair of first positive connectors P positioned a first distance d1 from the mirror line 29. A second pair of ground connectors G is positioned farther outward a distance d2 from the mirror line 29. A third pair of negative connectors N is positioned a distance d3 from the mirror line 29.

The mirrored arrangement provides for the panel 20 to be electrically connected to an adjacent structure when in two different orientations. The first side 21a provides for a first connection orientation, and the second side 21b provides for a second connection orientation.

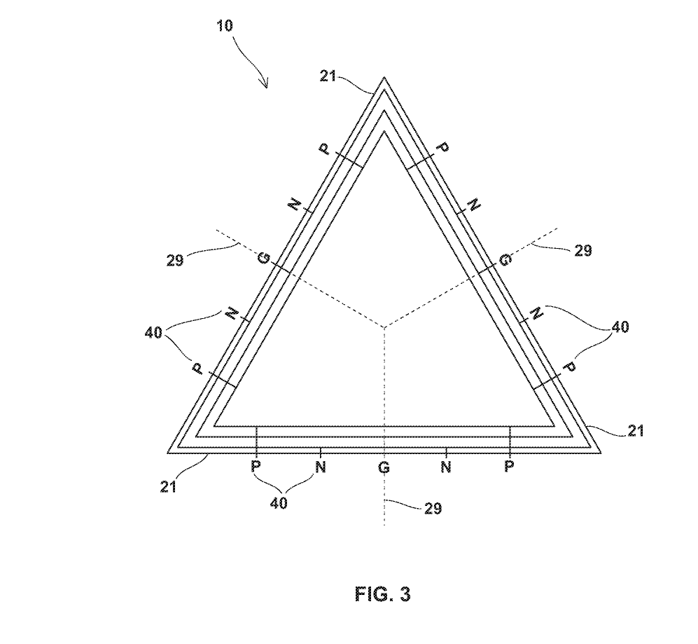

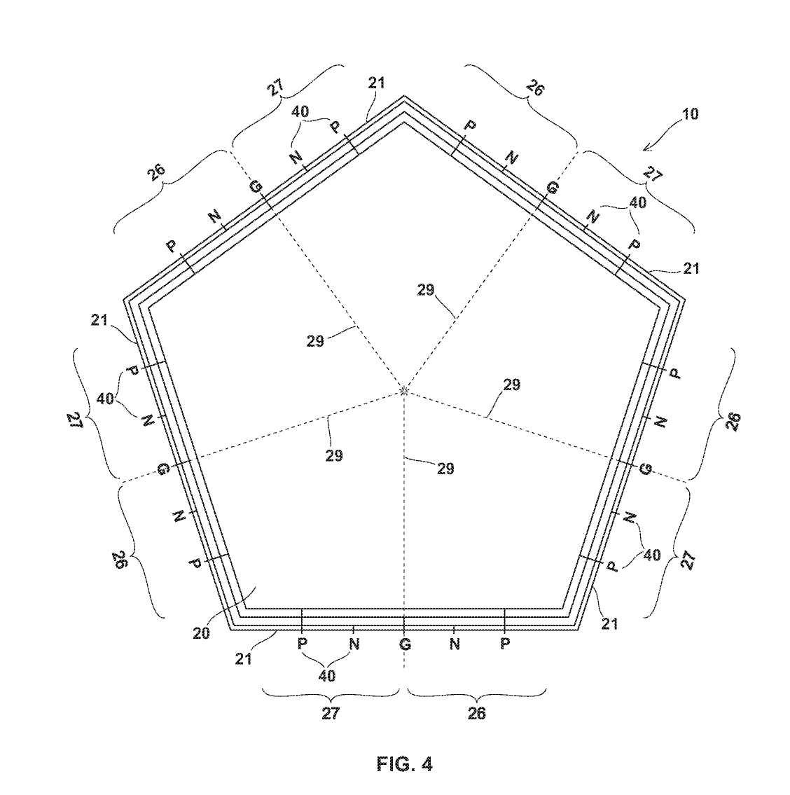

The panel body 20 can include a variety of different shapes and sizes. FIGS. 1 and 2 each include a panel body 20 with a rectangular shape. FIG. 3 includes a triangular shape with three sides 21 each with mirrored electrical connectors 40. FIG. 4 includes a panel body 20 with a pentagon shape having five sides 21. Other panel bodies 20 can include different numbers and shapes of sides 21.

With each of the panels 20, two or more of the outer sides 21 of the panel body 20 include electrical connectors 40 in a mirrored arrangement about a mirror line 29. The mirror line 29 is positioned at a center of the side 21 and equally distanced from the corners of the panel body 20. The connectors 40 are spaced relative to mirror line 29 at the center of the side 21. The sides 21 can be arranged such that a single co-linear mirror line 29 divides two of the sides 21 as illustrated in FIGS. 1 and 2. The sides 21 can also be arranged such that different lines 29 divide the sides 21 as illustrated in FIGS. 3 and 4. The panels 20 can include just two of the sides 21 with mirrored arrangements of electrical connectors 40 as illustrated in FIG. 2, or more than two as illustrated in FIG. 3 (three mirrored sides 21) and FIG. 4 (five mirrored sides 21).

The electrical connectors 40 are arranged in a mirrored arrangement in the sections 26, 27 on each side of the mirror line 29. This can include each of the connectors 40 being spaced away from the mirror line 29 as illustrated in FIG. 2. This can also include a connector 40 positioned on the mirror line 29 such that the connector 29 is part of each of the two opposing sections 26, 27. FIG. 3 includes a ground connector G positioned at the mirror line 29.

FIG. 4 includes a panel body 20 with a pentagon shape having five sides 21. Each of the sides 21 is divided by a separate mirror line 29. Again with this arrangement, a ground connector G is positioned along each side 21 at the mirror line 29 and is part of each section 26, 27. Each section 26, 27 along each of the sides 21 also includes a negative connector N and a positive connector P.

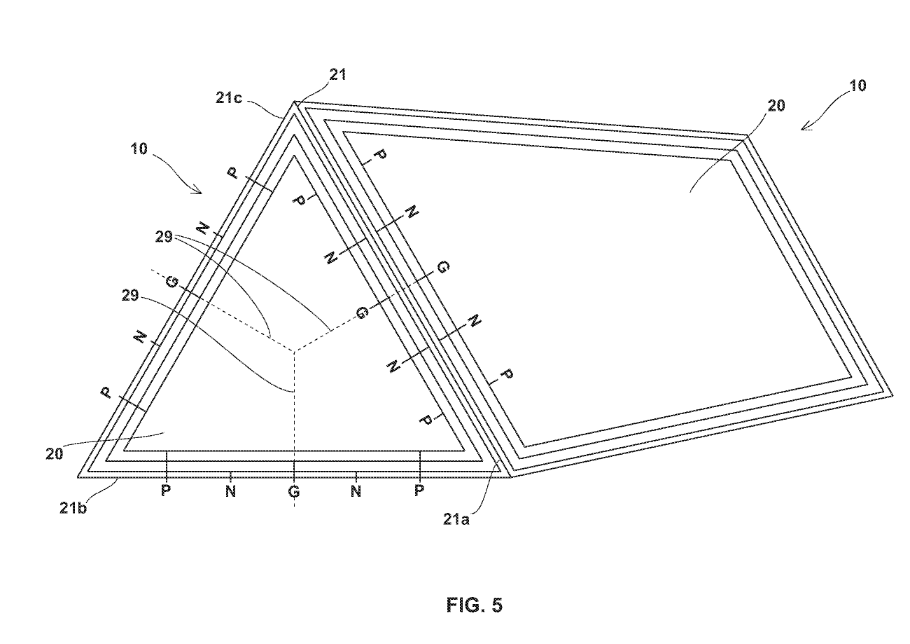

FIG. 5 illustrates a triangular panel 10 that can be connected in three different orientations to a second panel 10. The triangular panel 10 includes three sides 21a, 21b, 21c each with a mirrored arrangement of electrical connectors 40 configured to engage with the second panel 10.

As illustrated in FIGS. 3, 4, and 5, the connectors 40 with different polarities are connected to corresponding buses 30 with the same polarities. The buses 30 can connect to each of the connectors 40 on the panel 10 that have the same polarity. Further, the buses 30 can be continuous around the panel 10, or can be discontinuous to have separate endpoints.

A mirrored panel 10 includes at least two sides 21 with mirror connectors 40 to provide for connections in at least two different orientations. The panel 10 can include each of the sides 21 including mirror connectors 40 (e.g., FIGS. 3, 4, 5). The panel 10 can also include one or more of the sides not including mirror connectors 40 (e.g., FIG. 1, 2). The non-mirrored sides can be devoid of connectors 40, or can include connectors 40 in various other arrangements.

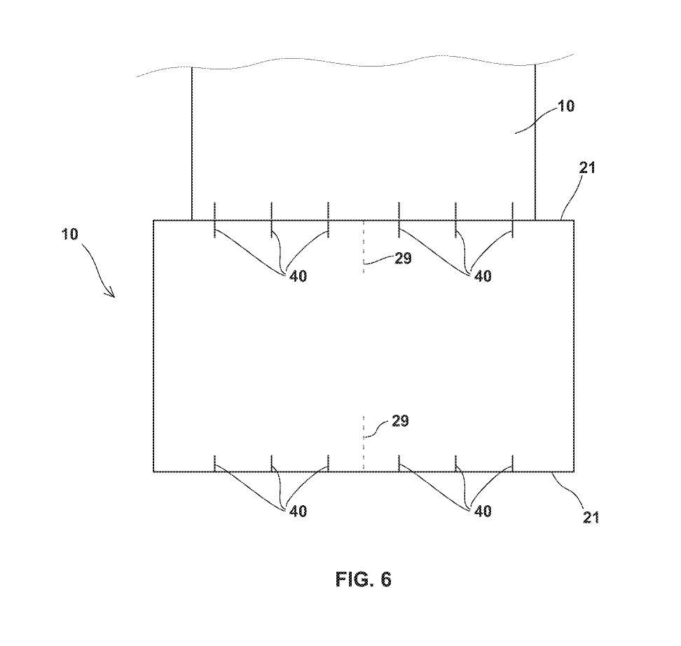

The sides 21 of the mirrored panel 10 can include different lengths than the panel 10 to which it is being connected. FIG. 6 illustrates an example in which a mirrored panel 10 includes sides 21 that are longer than the panel 10 to which it is being connected.

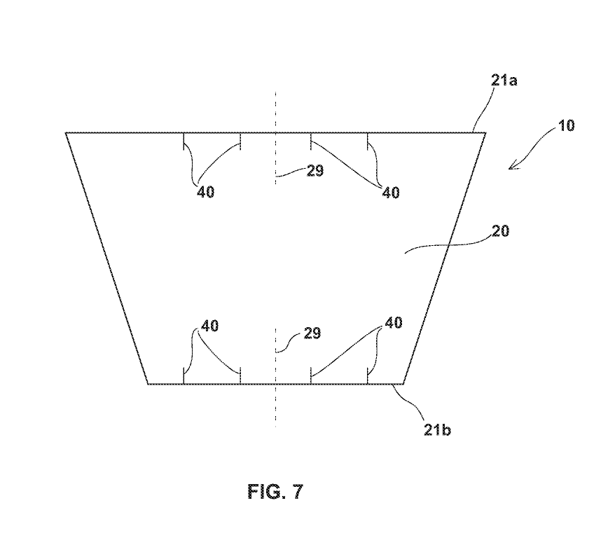

FIG. 7 illustrates a mirrored panel 10 with mirrored sides 21a, 21b. Each of the sides 21 includes a mirror line 29 with connectors 40 on opposing sides. As illustrated, the panel 10 includes a shape with the first side 21a being longer than the second side 21b. Each of the sides 21a, 21b is configured to engage with a structure with the same corresponding connectors despite the differences in the length.

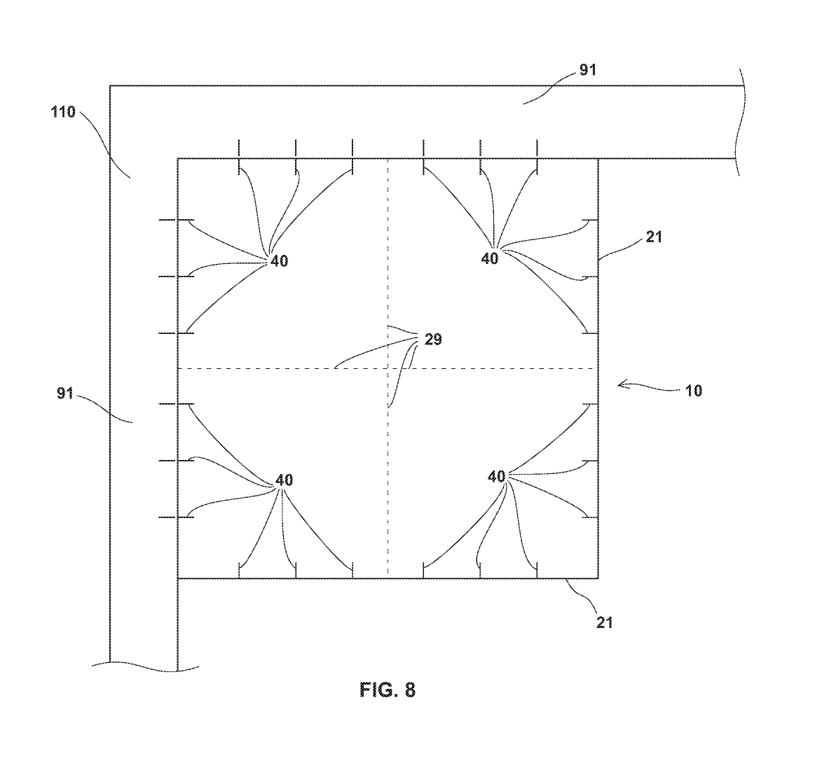

The mirrored panels 10 can also be connected to adjacent support members 110 simultaneously along two or more of the sides 21. FIG. 8 illustrates a panel 10 configured with four mirrored sides 21. Each of the sides 21 includes a mirrored set of connectors 40 positioned about a mirror line 29. The adjacent support members 110 include two mounting positions 91. Each of the positions 91 includes connectors configured to mate with the mirrored connectors 40 along each of the sides 21 of the panel 10. In this design, the panel 10 can be connected to the support members 110 in one of four different orientations that each provide for electrical connection.

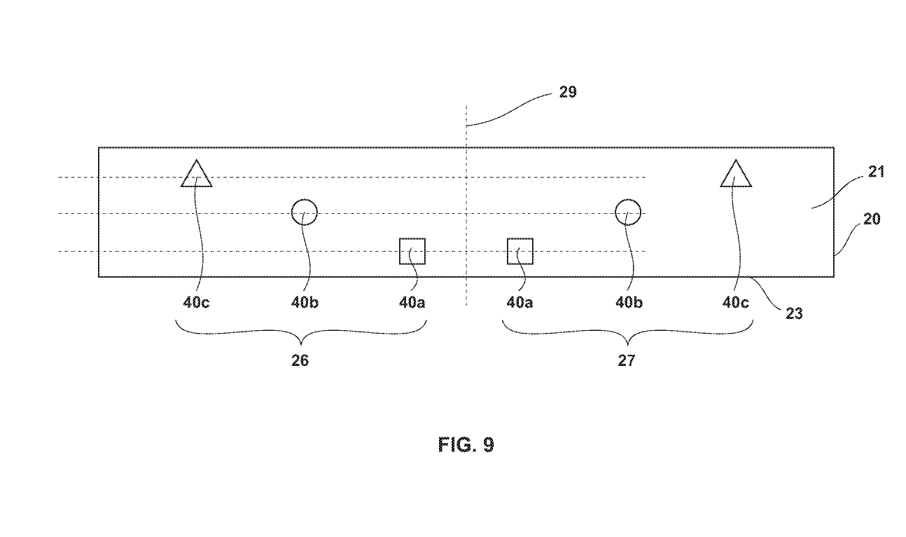

In the various designs, the connectors 40 can be positioned along a side 21 in a common plane. Other designs include the connectors 40 positioned in different planes. FIG. 9 illustrates a side 21 with connectors 40 positioned at different planes. The mirrored connectors 40 on each side of the mirror line 29 are positioned in the same vertical plane as well as the same horizontal distance. As illustrated, the first pair of connectors 40a are positioned the same distance from the mirror line 29 and at a same first vertical position. The second pair of connectors 40b are positioned at the same second distance from the mirror line 29 and at the same second vertical position. The third pair of connectors 40c are positioned at the same third distance from the mirror line 29 and at the same third vertical position.

Mirrored electrical connectors 40 can be used on a variety of different panel bodies 20. These include but are not limited to solar panels, wall panels, glass panels (e.g., windows, doors), ceiling panels, and internal building panels constructed from a variety of materials such as sheetrock, plywood, and fiberglass. One aspect includes a solar panel 10 configured to obtain usable solar power through photovoltaics. The panel 10 includes a top surface 22 with solar cells that absorb and convert sunlight into electricity.

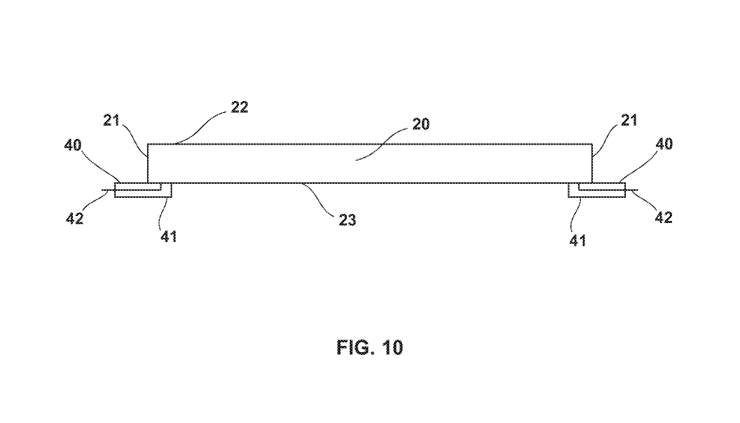

As illustrated in FIG. 10, the panel bodies 20 include opposing top and bottom surfaces 22, 23. The surfaces 22, 23 can each be planar to give the panel body 20 a constant thickness. The top and bottom surfaces 22, 23 can also include different configurations such that the panel body 20 has a varying thickness.

The electrical connectors 40 are configured to engage with the adjacent structure and provide an electrical connection. As illustrated in FIG. 10, each of the connectors 40 includes an arm 41 and an electrical contact 42. The electrical connectors 40 can extend outward beyond the outer sides 21 of the panel body 20 as illustrated in FIG. 10, or can be positioned inward from the outer sides 21. The electrical connectors 40 can be configured with the arms 41 statically positioned relative to the panel body 20. Alternatively, the arms 41 can be movable relative to the panel bodies 20 and configured to extend outward beyond the outer sides 21 and retract inward within the outer sides 21. The various electrical connectors 40 on the panel 10 can each be the same. Alternatively, two or more of the connectors 40 along a side 21 can be different.

The connectors 40 can be magnetically controlled to be selectively positioned between connected and unconnected positions. A tool can be used with the panel to provide a magnetic flux to move the connectors 40 between the positions. Magnetically controlled connectors and tools are disclosed in U.S. application Ser. No. 15/864,614 filed on Jan. 8, 2018 and which is hereby incorporated by reference in its entirety.

The electrical contacts 42 extend along at least a portion of the arms 41. The electrical contacts 42 can extend outward beyond the exposed ends of the arms 41 and/or can be exposed along a surface of the arms 41.

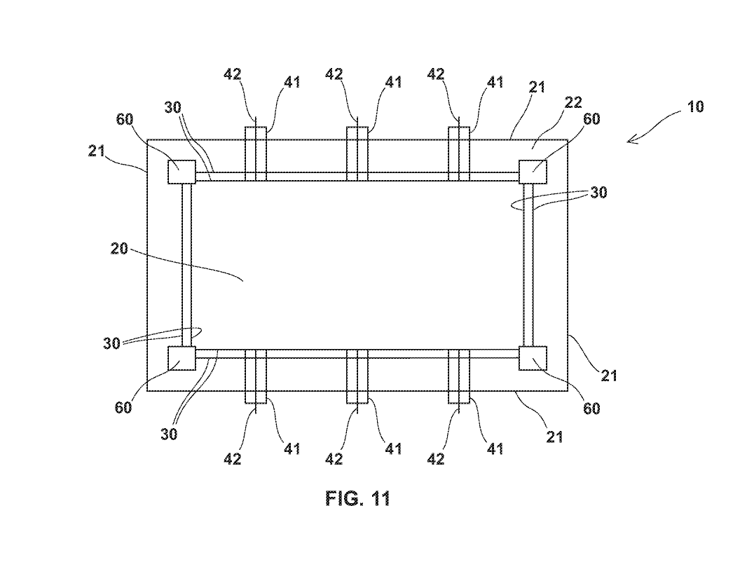

The electrical connectors 40 can be electrically connected to one or more electrical buses 30 as illustrated in FIG. 11. Each of the buses 30 can extend along one or more of the sides 21 of the panel body 20. The buses 30 provide for transmitting power along their length. The buses 30 can form a parallel mesh electrical grid such that the panel 10 does not require additional wiring. Nodes 60 can be positioned along the electrical buses 30 and include additional electrical components such as inverters, batteries, fuses, and charger controllers. The bus 30 and nodes 60 can provide for individually disconnecting each side 21 of the panel 10. This provides for a faulted panel 10 to be individually electrically isolated and removed from a larger grid of panels 10 without shutting down the entire grid.

Examples of panels with electrical connectors and electrical capability are disclosed in U.S. application Ser. No. 15/401,868 filed on Jan. 9, 2017, Ser. No. 15/471,664 filed on Mar. 28, 2017, Ser. No. 15/665,751 filed on Aug. 1, 2017, and Ser. No. 15/665,767 filed Aug. 1, 2017. Each of these applications is hereby incorporated by reference in its entirety.

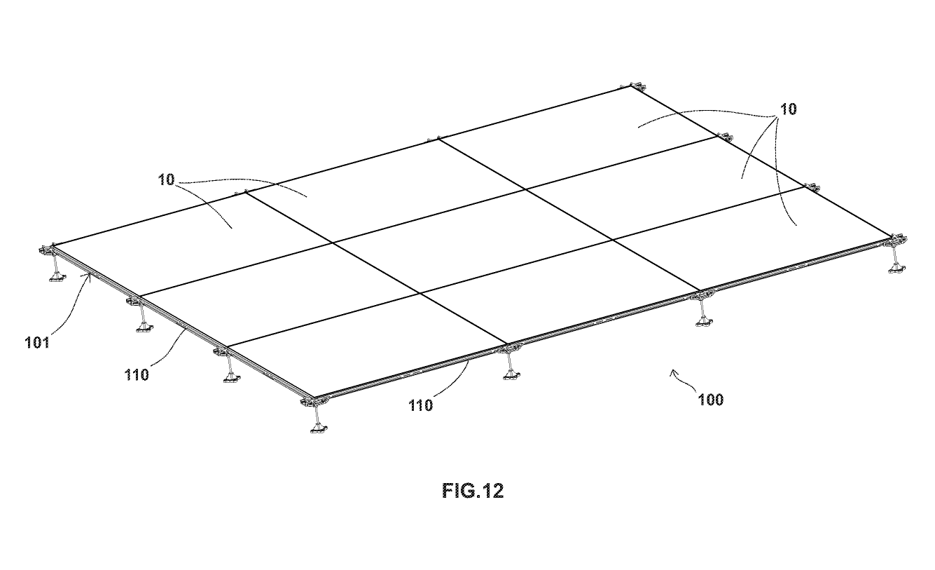

The panels 10 can be configured to provide for electrical connection with adjacent structures, such as adjacent panels 10 and/or support members 100. This can occur when the panels 10 are part of a larger array 100 as illustrated in FIG. 12. The array 100 includes a series of panels 10 arranged together in a single unit. The panels 10 are mounted on a frame 101 that includes support members 110 that engage with the panels 10. The connectors 40 on the panel 10 along at least one of the sides 21 engage with the one or more support members 110 and/or adjacent panels 10.

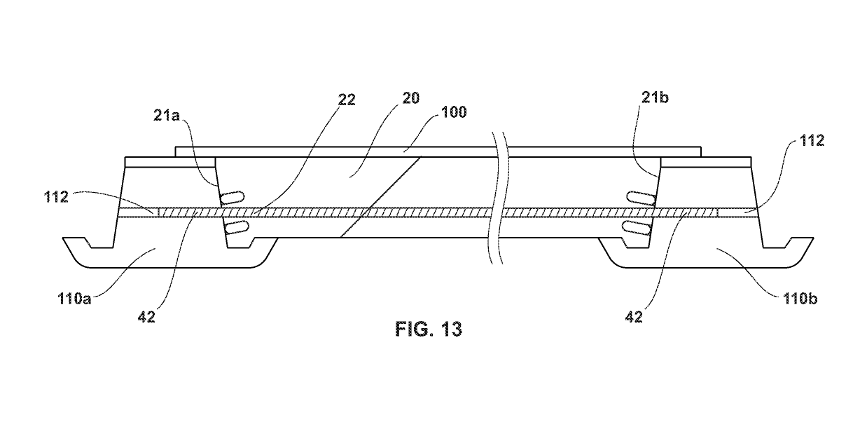

FIG. 13 illustrates a panel 10 attached to support members 110a, 110b. The panel 10 is positioned with a first side 21a positioned at a first support member 110a and a second side 21b positioned at a second support member 110b. The electrical contacts 42 of the electrical connectors 40 extend outward from each of the sides 21a, 21b. The electrical contacts 42 are positioned in slots 112 in the support members 110. Adjacent panels (not illustrated) that are positioned on opposing sides of the support members 110 include similar electrical contacts 42 that extend into the slots 112 from the opposing direction. The electrical connectors 42 of the adjacent panels contact together to provide for electrical connectivity with each other.

The first and second sides 21a, 21b include mirrored arrangements of connectors 40. Thus, the panel 10 can be attached to the support members 110 in at least two orientations. In one design, the electrical contacts 42 are movable relative to the panel body 20. The contacts 42 are movable between an extended position that are inserted within the slots 112, and a retracted position positioned out of the slots 112.

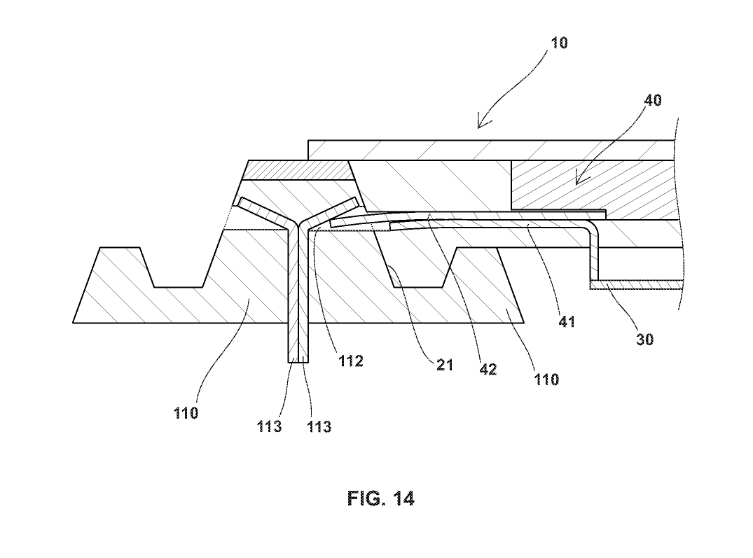

The electrical connectors 40 can include other configurations to engage with the support members 110. FIG. 14 illustrates a support member 110 that includes an electrical contact 113. When the panel 10 is connected to the support member 110, the electrical contact 42 extends outward from the side 21 of the panel 10 and into a slot 112 in the support member 110. The electrical contact 42 contacts against the electrical contact 113 to provide for electrical connection with the support member 110. The support member 110 can be configured to include a corresponding electrical contact 113 for connecting electrically with an adjacent panel (not illustrated).

With the panel 10 electrically connected, electricity from the panel 10 moves along the electrical connector 40 to the electrical contact 113 in the support member 110. This can include along the electrical bus 30, and electrical contacts 41, 42. In this design, the electrical connectors 40 provide for transferring the electrical power from the panels 10 out of the support member 110 to a remote entity.

The connectors 40 are configured to also provide for panel-to-panel connections. Thus, the buses 30 of the panels can be electrically and/or communicatively connected together. This provides a continuous grid system with connectivity amongst multiple panels 10. This provides for a panel 10 to communicate through the grid to one or more other panels 10. This also provides for communications and/or electrical power to move through the grid by moving through multiple panels 10 in the grid.

In one design, the panel 10 is a solar panel that includes a series of interconnected solar cells. The solar cells use light energy from the sun to generate electricity through the photovoltaic effect. The solar cells may include various structures, including but not limited to wafer-based crystalline silicon cells or thin-film cells based on cadmium, telluride or silicon. The solar panels 10 may include a variety of different shapes and sizes. The buses 30 and electrical connectors 40 can be used to transmit the power from the panel 10 to an adjacent structure.

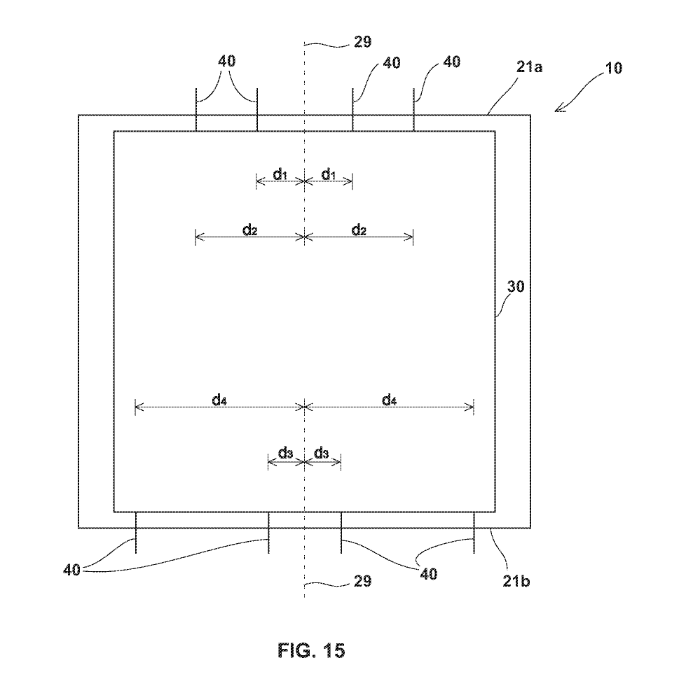

FIG. 15 illustrates a panel 10 with different spacing of connectors 40 on different panel sides 21. The first side 21a includes mirrored connectors with a first set of connectors 40 each positioned a distance d1 from the mirror line 29. The first side 21a also includes a second set of connectors 40 positioned a second distance d2 away from the mirror line 29. The second side 21b including different spacing with a third pair of connectors 40 each positioned a third distance d3 away from the mirror line 29 and a fourth pair of connectors 40 each positioned a fourth distance d4 away from the mirror line 29. The distances d3 and d4 are different than distances d1 and 2.

The mirrored arrangement on a first side of the panel body 20 can be different than the mirrored arrangement on a second side of the panel body 20. The difference can include but is not limited to number of electrical connectors 40, spacing, and polarity.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

1. A panel comprising:
a thin body with relatively large first and second surfaces and relatively narrow outer edges that extend between the first and second surfaces; and
a mirrored arrangement of electrical connectors positioned along at least three of the outer edges, each of the at least three outer edges comprising a mirrored arrangement with a mirror line that intersects a center of the outer edge and divides the outer edge into equal first and second sides with a first arrangement of the electrical connectors on the first side of the mirror line, and a second arrangement of the electrical connectors mirrored on the opposing second side of the mirror line, the first and second arrangements comprise a common number, electrical attribute, and spacing of the electrical connectors relative to the mirror line.

2. The panel of claim 1, wherein for each of the first and second arrangements of the electrical connectors comprise at least one ground connector, at least one positive electrical connector, and at least one negative electrical connector.

3. The panel of claim 2, wherein each of the first and second arrangements of the electrical connectors share a single connector that is positioned on the mirror line.

4. The panel of claim 1, wherein the mirrored arrangement of electrical connectors is positioned on each of the outer edges of the body.

5. The panel of claim 1, wherein the mirror lines of two of the outer edges of the body are co-linear.

6. The panel of claim 1, wherein the mirrored arrangement of a first one of the outer sides is different than the mirror arrangement of a second one of the outer sides.

7. (canceled)

8. The panel of claim 1, wherein the electrical connectors are electrically connected to electrical buses that are positioned on the body with a first pair of the electrical connectors connected to a first one of the electrical buses and a second pair of the electrical connectors connected to a second one of the electrical buses.

9. A panel comprising:
a body with a first surface and an opposing second surface, the body also comprising a first outer edge, a second outer edge, and a third outer edge, the first and second surfaces being larger than the first, second, and third outer edges; and
a mirrored arrangement of electrical connectors positioned along each of the first, second, and third outer edges, each of the mirrored arrangements comprising:
a mirror line that equally divides the outer edge;
at least four connectors comprising:
a first pair of the connectors comprising first and second connectors that each have a first electrical attribute, the first connector positioned a first distance away from the mirror line on a first side of the mirror line and the second connector positioned the first distance away from the mirror line on a second side of the mirror line;
a second pair of the connectors comprising third and fourth connectors that each have a different second electrical attribute than the first electrical attribute, the third connector spaced away from the first connector and positioned a second distance away from the mirror line on the first side of the mirror line and the fourth connector spaced away from the second connector and positioned the second distance away from the mirror line on the second side of the mirror line.

10. The panel of claim 9, wherein each mirrored arrangement further comprises a fifth connector with a third electrical attribute that is different than both of the first and second electrical attributes, the fifth connector positioned at the mirror line.

11. (canceled)

12. The panel of claim 9, wherein each of the mirrored arrangements further comprises a third pair of connectors comprising fifth and sixth connectors, the fifth connector spaced away from the first and third connectors and positioned a third distance away from the mirror line on the first side of the mirror line and the sixth connector spaced away from the second and fourth connectors and positioned the third distance away from the mirror line on the second side of the mirror line.

13. The panel of claim 9, wherein one of the first and second pair of electrical connectors has a negative polarity and the other of the first and second pair of electrical connectors has a positive polarity.

14. (canceled)

15. The panel of claim 9, wherein for each of the mirrored arrangements comprises at least one ground connector, at least one positive electrical connector, and at least one negative electrical connector.

16. The panel of claim 9, further comprising first and second electrical buses connected to the body, the first electrical bus connected to the first pair of the connectors and the second electrical bus connected to the second pair of the connectors.

17. The panel of claim 9, wherein the mirror lines are co-linear.

18. (canceled)

19. A method of electrically connecting a panel to an adjacent structure, the method comprising:
positioning a first edge of the panel towards the structure while a second edge of the panel faces away from the structure;
aligning a first set of electrical connectors that extend along the first edge of the panel with corresponding electrical connectors that extend along the structure, the first set of electrical connectors aligned along first and second sections of the first edge that are positioned on opposing sides of a mirror line that equally divides the first edge of the panel and with the first set of electrical connectors having identical spacing and type of connectors;
while aligning the first set of electrical connectors with the structure, positioning a second set of electrical connectors that extend along the second edge of the panel away from the structure, the second set of electrical connectors having the identical spacing and type of connectors as the first set of electrical connectors; and
electrically connecting the first set of electrical connectors with the corresponding electrical connectors on the structure and positioning the second set of electrical connectors away from the structure.

20. The method of claim 19, further comprising:
disconnecting the first set of electrical connectors from the corresponding electrical connectors on the structure while a first surface of the panel faces in a first direction;
positioning the second edge of the panel towards the structure while the first surface of the panel remains facing in the first direction; and
electrically connecting the second set of electrical connectors with the corresponding electrical connectors on the structure and positioning the first set of electrical connectors away from the structure while the first surface of the panel faces in the first direction.

21. The panel of claim 1, wherein the panel is a solar panel configured to obtain usable solar power through photovoltaics.

22. The panel of claim 1, wherein the panel is a wall panel.

23. The panel of claim 1, wherein the panel is a building panel.

24. The panel of claim 9, wherein the panel is a solar panel configured to obtain usable solar power through photovoltaics.

25. The panel of claim 9, wherein the panel is a wall panel.

26. The panel of claim 9, wherein the panel is a building panel.

27. The panel of claim 9, wherein the first outer side and the second outer side include different lengths.
